(19) United States
(12) Patent Application Publication
(10) Pub. No.: US 2011/0162634 A1
(43) Pub. Date: Jul. 7, 2011

(54) Portable barbecue

(76) Inventor: Ronald R. Richard, Morse, LA (US)

(21) Appl. No.: 12/654,860

(22) Filed: Jan. 6, 2010

(51) Int. Cl. A47J 37/07

(52) U.S. Cl. 126/25 R

(57) ABSTRACT

The portable barbecue has a central fire pit supported by a surrounding table assembly. The table assembly is formed of identical shorter angular sections that are assembled together to form a table that completely surrounds the fire pit. The removable fire pit includes an outwardly extending flange that rests upon the inner edge of the table assembly to support the fire pit well clear of any underlying structure. The table assembly includes a plurality of sockets for removable legs, the fire pit being devoid of any such leg attachment or support. The table assembly is thus self-supporting without the fire pit installed therein. The table assembly may be formed of four sections to have an octagonal shape with four removable legs and an octagonal central opening, the fire pit having a shape congruent to the central opening of the fire pit.

### BACKGROUND OF THE INVENTION

1. Field of the Invention

The present invention relates generally to food preparation and cooking appliances, and particularly to a portable barbecue having a central fire pit and surrounding table that holds the fire pit in a central receptacle thereof.

2. Description of the Related Art

Outdoor cooking, and particularly barbecuing, has become increasingly popular as conventional cooking has evolved into an indoor activity in the home. While many homes, community parks, and campsites have permanently installed barbecues, the portable barbecue is a popular accessory for many households that prefer the portability of such a unit to allow it to be transported to picnics, sporting events, and other activities removed from the home.

The conventional portable barbecue is a relatively simple device, comprising a fire pit with a cooking grill resting thereacross and three or four supporting legs. Typically, such barbecues have no table or other work surface attached thereto or extending therefrom, in order to simplify their breakdown for transport and storage. This results in some limitations in the use of such a relatively simple appliance, since there is no adjacent or attached surface upon which utensils and food may be placed during the cooking process.

Thus, a portable barbecue solving the aforementioned problems is desired.

### SUMMARY OF THE INVENTION

The portable barbecue includes a central fire pit having a removable cooking grill thereon. The fire pit is removably supported within the central receptacle of a table assembly. The table assembly has several sections that may be disassembled for portability and convenient storage. A plurality of legs are removably attached to the table assembly, rather than to the fire pit. The fire pit is supported well clear of the underlying surface entirely by the table assembly. A removable lid or cover is also provided for the fire pit and grill.

The table assembly preferably comprises four separable and identical sections. Each section subtends one-quarter of the entire table assembly and the central fire pit receptacle. Each section of the table includes means for removable attachment to the adjacent section at a 45° angle thereto, and a socket for a removable supporting leg. Each section preferably has a somewhat V-shaped planform, with the two arms of the V forming an angle of 45° to one another. The four table sections thus form an octagonal ring around the central fire pit receptacle. The fire pit has a similar shape with an outwardly extending flange that rests upon the inner edge of the table assembly when the barbecue is assembled.

These and other features of the present invention will become readily apparent upon further review of the following specification and drawings.

### BRIEF DESCRIPTION OF THE DRAWINGS

FIG. 1 is an environmental, perspective view of a portable barbecue according to the present invention, illustrating its general configuration and use.

FIG. 2 is an exploded perspective view of the portable barbecue according to the present invention, showing its various components and their relationships to one another.

FIG. 3 is a partial exploded bottom perspective view of the portable barbecue according to the present invention, showing portions of adjacent sections of the table and one leg, illustrating details of their assembly.

Similar reference characters denote corresponding features consistently throughout the attached drawings.

### DETAILED DESCRIPTION OF THE PREFERRED EMBODIMENTS

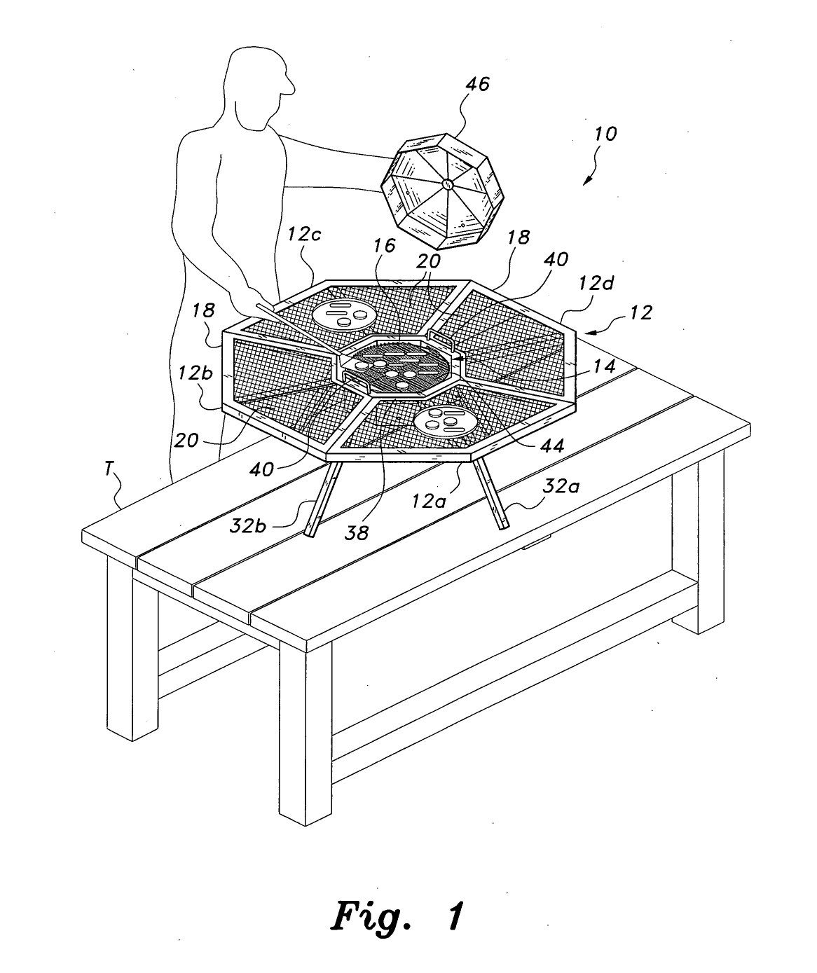

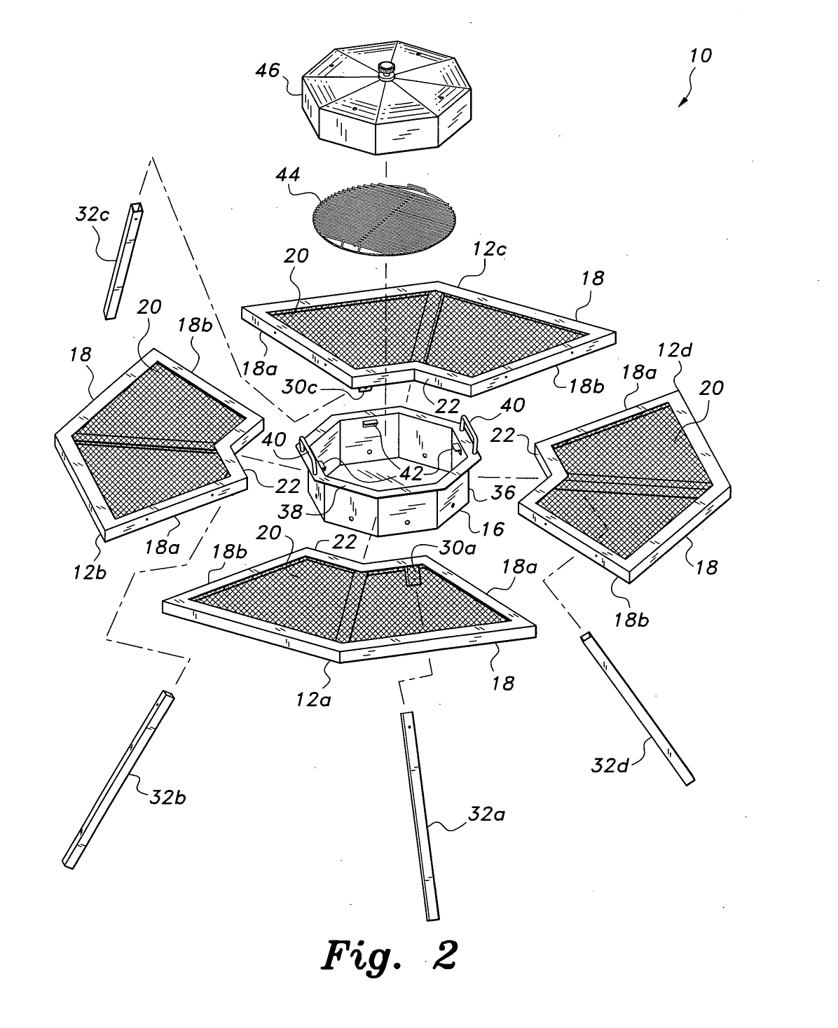

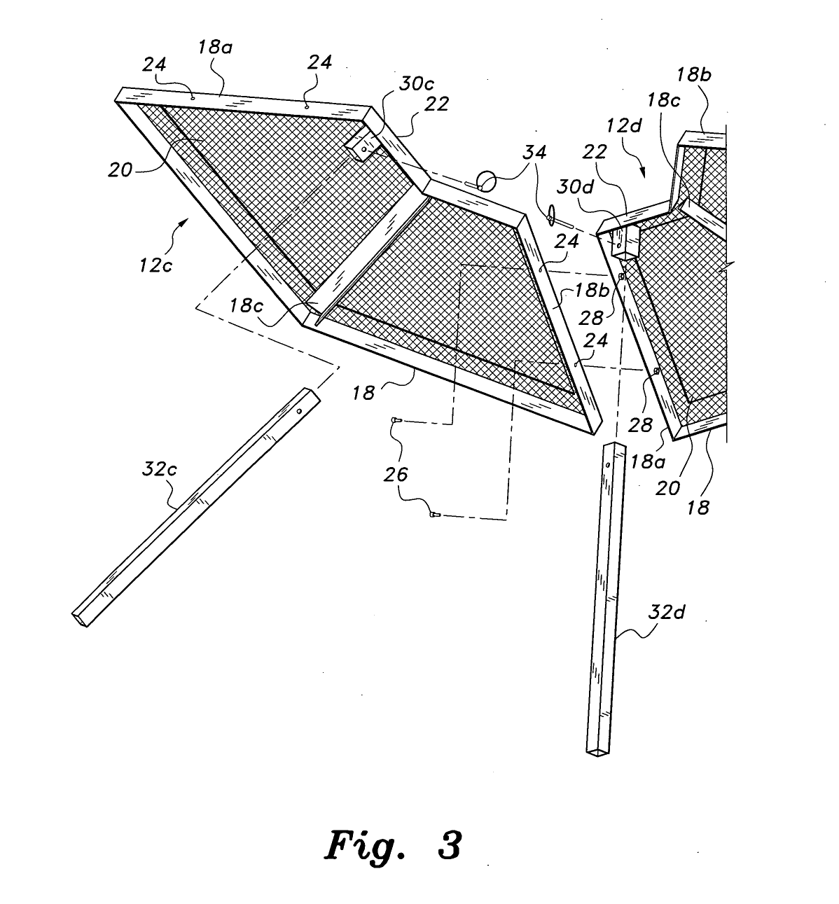

The portable barbecue has a central fire pit with a surrounding table that can be disassembled to facilitate transport and storage. FIG. 1 of the drawings provides an environmental perspective view of the assembled portable barbecue 10, with FIG. 2 providing an exploded perspective view of the barbecue 10 and FIG. 3 providing table assembly details. The portable barbecue 10 comprises an octagonal table 12 having a central fire pit receptacle 14 therein, with the fire pit 16 being removably installable within its receptacle 14 in the table 12. The table 12 is formed of four identical sections 12a, 12b, 12c, and 12d, with the four table sections attaching to one another along their mating edges to form a coplanar assembly comprising the table 12.

FIG. 3 of the drawings provides a detailed illustration of a single table section 12c and a portion of the adjoining table section 12d. Each of the table sections 12a through 12d has a peripheral frame 18 formed of angle iron or other suitable materials as desired. The table surface 20 of each table section is formed of expanded metal screen for strength, durability, heat resistance, and ease of cleaning. Each frame 18 includes three radially disposed members, with two of the members 18a and 18b defining the ends of the section and the third member 18c defining a centerline of the table section, with the two portions of the section extending to either side of the central member 18c forming a 45 degree angle therebetween. It will be seen that this configuration forms one quadrant of an octagon, with the completely assembled table 12 comprising the four table sections 12a through 12d forming an octagonal table configuration. The fire pit receptacle 14 also has an octagonal configuration, as defined by the eight inner members of the table section frame 18 that form the receptacle edge 22 for the fire pit 16.

The two opposite end members 18a and 18b of each section are at 90 degrees to one another, and attach to the corresponding end member of the adjacent table section for assembly of the table 12. In FIG. 3, the second end member 18b of the table section 12c is shown prior to attachment to the mating first end member 18a of the adjacent table section 12d. Each of the end members 18a and 18b includes a plurality of bolt or fastener holes 24, with corresponding bolts 26 inserting through the holes to fasten the table sections to one another. The end members 18b may include nuts 28 or other suitable fasteners permanently installed thereto, to facilitate assembly.

Each of the identical table sections 12a through 12d includes a leg socket or receptacle, respectively 30a through 30d, extending downwardly and at an outward angle from the inner or fire pit receptacle edge member 22 thereof. Corresponding legs 32a through 32d install removably in these sockets 30a through 30d and are secured therein by removable pins 34, as shown in FIG. 3 of the drawings. The four legs 32a through 32d thus support the table 12 directly and hold the table 12 above and well clear of the underlying surface, e.g., the picnic table T shown in FIG. 1. Thus, the legs 32a through 32d do not directly contact or support the fire pit 16, and accordingly heat transfer from the fire pit to the legs and any underlying support structure is greatly reduced. In addition, the fire pit 16 is held above and well clear of the underlying structure due to its resting within the fire pit receptacle 14 of the table 12, further reducing any potential fire hazard.

FIGS. 1 and 2 illustrate the removable installation of the fire pit 16 into its receptacle 14 of the table 12, with FIG. 1 showing the fire pit completely installed in the table. The fire pit 16 has an octagonal planform or periphery 36 that is essentially congruent with the octagonal fire pit receptacle 14 of the assembled table 12, i.e., the fire pit 16 fits closely therein and is completely surrounded by the table 12 with little or no looseness or play between the fire pit 16 and the inner or fire pit receptacle edge 22 of the table 12. The upper edge or rim of the fire pit 16 includes an outwardly extending flange 38 that rests atop the fire pit receptacle edge 22 of the table 12, to support the fire pit 16 within the table 12 and prevent the fire pit from falling through the receptacle 14 of the table 12 when the fire pit 16 is installed therein.

The fire pit 16 further includes additional features to facilitate its use, e.g., opposed handles 40 that extend upwardly from the upper edge thereof, or more specifically from the flange 38 to facilitate the installation and removal of the fire pit 16 into and from its receptacle 14 in the table 12. The fire pit 16 also includes a series of inwardly oriented grill support tabs 42 disposed adjacent to the upper rim and generally opposite the outwardly oriented flange 38, as shown in FIG. 2, for the support of the cooking grill 44 thereon. Additional grill support tabs (not shown) may be arranged vertically to allow the height of the grill 44 to be adjusted as desired. Also, a cover or lid 46 may be placed over the fire pit 16 and grill 44 as desired to produce additional smoking of the food being cooked and/or to protect persons from the heat of the cooking operation, etc. The cover or lid 46 also preferably has an octagonal shape, with the rim of the cover dimensioned to rest atop the flange 38 of the fire pit and within its handles 40.

The portable barbecue 10 breaks down to a relatively small package, with the four identical table sections 12a through 12d stacking atop one another and the fire pit 16 having a width very little, if any, greater than the widths of the table sections. The four legs 32a through 32d are readily removed from their table sections for further compact storage and transport. The portable barbecue 10 is easily reassembled in a matter of a few minutes, when desired. The four table sections 12a through 12d are bolted or otherwise rigidly secured together, and the four legs 32a through 32d are pinned in their corresponding sockets 30a through 30d depending from the inner or fire pit receptacle edge 22 of the assembled table 12. The assembly may be placed as desired, e.g., atop a table T as shown in FIG. 1 in the case of relatively short legs, or directly upon the ground or other surface if longer legs are provided. The fire pit 16 is then placed in its receptacle 14 with the table assembly 12 completely surrounding the fire pit, and charcoal or other combustible material is placed in the fire pit 16 and ignited to ready the barbecue 10 for cooking. When the use of the portable barbecue has been completed, the fire pit 16 is emptied and the various components (fire pit 16, legs 32a through 32d, and table sections 12a through 12d) are disassembled for cleaning, transport, and/or storage, readiness for the next use.

While the portable barbecue 10 disclosed herein has been described as having an octagonal configuration, it should be noted that other configurations may also be adapted to the concept. For example, three identical table sections each subtending 120 degrees and having a leg socket depending therefrom could be provided, with the fire pit receptacle and fire pit being configured accordingly, i.e., having hexagonal shapes. Alternatively, the various sections of the table could be configured to have a round circumference when assembled, with the fire pit receptacle and fire pit having similar round planforms. Regardless of the specific shape or planform of the device, the fire pit with its completely surrounding table that can be disassembled for transport and storage, greatly facilitates the use of such a barbecue.

It is to be understood that the present invention is not limited to the embodiment described above, but encompasses any and all embodiments within the scope of the following claims.

I claim:

1. A portable barbecue, comprising:
a table having a central fire pit receptacle therein, the table being formed of a plurality of mutually identical table sections, the table sections being removably attached to one another to form the table, and
a fire pit removably disposed within the fire pit receptacle of the table, the fire pit being completely surrounded by the table when placed within the fire pit receptacle of the table.

2. The portable barbecue according to claim 1, further comprising a plurality of legs depending from the table, the legs supporting the table above and well clear of any underlying surface, the fire pit being supported solely by the table, the fire pit being disposed above and well clear of the underlying surface when installed with the table.

3. The portable barbecue according to claim 2, wherein each of the table sections has an inner peripheral member and a leg socket depending from the inner peripheral member, each of the legs being removably installed in the leg socket of a corresponding one of the table sections.

4. The portable barbecue according to claim 1, wherein:
the fire pit receptacle has a receptacle edge; and
the fire pit has an upper edge having a flange extending outwardly therefrom, the flange resting atop the receptacle edge of the table to support the fire pit within the fire pit receptacle of the table when the fire pit is placed therein.

5. The portable barbecue according to claim 1, wherein each of the table sections comprises a peripheral frame of angle iron material and an expanded metal surface.

6. The portable barbecue according to claim 1, wherein the table has four table sections, the table and the fire pit receptacle each being octagonal, the fire pit having an octagonal periphery congruent with the octagonal planform of the fire pit receptacle.

7. The portable barbecue according to claim 1, wherein the fire pit has an upper edge and a plurality of handles extending from the upper edge.

8. A portable barbecue, comprising:
a table;
a plurality of legs depending from the table, the legs supporting the table above and well clear of an underlying surface; and
a fire pit removably installed in the table, the fire pit being supported solely by the table, the fire pit being disposed above and well clear of the underlying surface when installed with the table.

9. The portable barbecue according to claim 8, wherein:
the table is formed of a plurality of mutually identical table sections, the table sections being removably attached to one another to form the table, the table defining a central fire pit receptacle therein when assembled to form the table; and
the fire pit is removably disposed within the fire pit receptacle, the fire pit being completely surrounded by the table when placed within the fire pit receptacle.

10. The portable barbecue according to claim 9, wherein each of the table sections has an inner peripheral member and a leg socket depending from the inner peripheral member, each of the legs being removably installed in the leg socket of a corresponding one of the table sections.

11. The portable barbecue according to claim 9, wherein each of the table sections comprises a peripheral frame of angle iron material and an expanded metal surface.

12. The portable barbecue according to claim 9, wherein the table has four table sections, the table and the fire pit receptacle each being octagonal, the fire pit having an octagonal periphery congruent with the octagonal fire pit receptacle.

13. The portable barbecue according to claim 8, wherein:
the table has a central fire pit receptacle therein, the fire pit receptacle having a receptacle edge; and
the fire pit has an upper edge having a flange extending outwardly therefrom, the flange resting atop the receptacle edge to support the fire pit within the fire pit receptacle when the fire pit is placed therein.

14. The portable barbecue according to claim 8, wherein the fire pit has an upper edge and a plurality of handles extending from the upper edge.

15. A portable barbecue, comprising:
a table defining a central fire pit receptacle, the fire pit receptacle having a receptacle edge; and
a fire pit having an upper edge and a flange extending outwardly from the upper edge, the flange resting atop the receptacle edge to support the fire pit within the fire pit receptacle when the fire pit is placed therein.

16. The portable barbecue according to claim 15, wherein the table is formed of a plurality of mutually identical table sections, the table sections being removably attached to one another to form the table, the fire pit being completely surrounded by the table when placed within the fire pit receptacle.

17. The portable barbecue according to claim 16, wherein each of the table sections has an inner peripheral member having a leg socket depending therefrom, a leg being removably installed in the leg socket of each of the table sections, the legs supporting the table and the fire pit disposed therein well clear of an underlying surface.

18. The portable barbecue according to claim 16, wherein each of the table sections comprises a peripheral frame of angle iron material and an expanded metal surface.

19. The portable barbecue according to claim 16, wherein the table is formed of four table sections, the table and the fire pit receptacle each having an octagonal planform, the fire pit also being octagonal.

20. The portable barbecue according to claim 15, wherein the fire pit has an upper edge and a plurality of handles extending from the upper edge.
